(19) United States
(12) Patent Application Publication
(10) Pub. No.: US 2010/0203469 A1
(43) Pub. Date: Aug. 12, 2010

(54) ORAL HYGIENE

(75) Inventor: Timothy Nathaniel Stewart, Birmingham (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: SEAGREEN HOLDING COMPANY LIMITED, George Town (KY)

(21) Appl. No.: 12/302,428

(22) PCT Filed: May 31, 2007
(86) PCT No.: PCT/GB2007/002016

§ 371 Date: Dec. 22, 2008

(30) Foreign Application Priority Data
May 31, 2006 (GB) 0610727.0

(51) Int. Cl. A61C 17/02; A46B 9/04

(52) U.S. Cl. 433/90; 15/167.1

(57) ABSTRACT

This invention relates to oral hygiene in particular to oral hygiene means comprising a chamber for active fluid to which a first passageway in a toothbrush is connectable, a flexible panel on the chamber, a piston to co-operate with the flexible panel, a drive means for the piston, a spent fluid chamber to which a second passageway in a toothbrush is connectable, and a means of creating a low or negative pressure connected to the spent fluid chamber, at least the chamber for fluid being disposable and replaceable for each oral hygiene operation.

This invention relates to oral hygiene, and is particularly, but not necessarily exclusively concerned with the provision of a portable oral hygiene means suited to bedridden users, others who find themselves medically challenged, and those who for whatever permanent or temporary reason are not able to clean their own teeth properly.

The practice of oral hygiene in hospitals or other institutions has lacked attention and staff training, and has been treated as routine or mundane, when it is clearly not, there being growing evidence of how important it can be that oral hygiene is properly practiced.

Effective cleaning of teeth or other oral hygiene practices needs the provision of fluid to the mouth, medicated or non-medicated, to serve as a cleaning medium or to assist the cleaning action of such as a paste. Fluid can also be required as a hygienic mouthwash. With bedridden persons, particularly those that are comatose or semi-comatose, and with persons who have suffered such as strokes or who suffer from such as arthritis, applying a fluid to and removing fluid from the mouth can be particularly difficult to the person him or herself, to staff personnel in hospitals or other institutions, or to home helps who are largely untrained in such matters.

It has been recognised previously that there can be a benefit in adapting a toothbrush to allow its connection to a source of fluid under pressure or to a delivery system, the brush being so structured that a supply of fluid emerges through or in close proximity to the bristle head. It has also been recognised that there is an advantage in attempting to cause the removal of fluid from the mouth through the brush, by having a passageway through the brush that has an inlet opening at or in close proximity to the bristle head that is connected to a source of vacuum. Such an arrangement can be found in U.S. Pat. No. 4,672,953. However, the supply of fluid to the mouth requires the correct activation of valve means on the brush, not easily effected by persons with any form of medical impediment, and which requires still to be exercised by a helper to ensure that fluid is supplied to the mouth in volumes that do not flood the patients mouth, with the danger of that to a prone patient who might be comatose. Also, vacuum applied to the mouth can cause considerable discomfort if a patients mouth inadvertently closes around the brush handle, a problem attended to by European Patent 0557337, where an air bleed passageway is provided through the handle beyond the point that can be reached by the lips of the patient, and to the vacuum line in the handle, to allow air to be drawn into a vacuum tube if the patients mouth closes on to the brush handle. However the fluid delivery system and recovery systems disclosed in European Patent 0557337 are cumbersome and require the periodic filling of a fluid delivery chamber and emptying of a spent fluid chamber, and has hygiene implications that would not meet requirements as they currently exist.

A first objective of the invention is to provide an oral hygiene means ideally suited both to hospital or other institutional use, and to use by bedridden users and others not able to clean their own teeth properly at home and a second object of the present invention to provide an oral hygiene means that avoids those disadvantages mentioned above.

According to a first aspect of the invention, oral hygiene means comprises a chamber for active fluid to which a first passageway in a toothbrush is connectable, a flexible panel on the chamber, a piston to co-operate with the flexible panel, a drive means for the piston, a spent fluid chamber to which a second passageway in a toothbrush is connectable, and a means of creating a low or negative pressure connected to the spent fluid chamber, at least the chamber for fluid being disposable and replaceable for each oral hygiene operation.

Ideally the spent fluid chamber is also disposable and replaceable for each oral hygiene operation, and preferably the chamber for fluid and the spent fluid chamber are a combined unit. A toothbrush of known type e.g. as disclosed in U.S. Pat. No. 6,315,556, with first and second passageways for fluid may be provided, the first passageway being connected to the chamber for active fluid and the second passage connected to the spent fluid chamber. To avoid the build-up of vacuum in a user's mouth, a bleed passage may be provided at the brush, connecting the second passageway to atmosphere, beyond the position where a patients' mouth could close onto the brush handle.

According to a second aspect of the invention, a cartridge for use in oral hygiene means comprises a first chamber to serve as a spent fluid chamber, an outlet from the first chamber for connection to a source of low or negative pressure, an inlet to the first chamber for connection to a brush, there being a second chamber within the first chamber to contain active fluid, the second chamber extending from a co-operating hole in a wall of the cartridge, with a flexible membrane overlying the hole and being in sealing engagement with the wall of the cartridge around the hole, and an outlet connection from the second chamber for connection to a brush. The second chamber may be formed as a recess on the opposite wall of the cartridge to the wall with the hole, the wall of the recess extending across the cartridge and into sealing engagement with the wall around the hole.

Desirably, gripping means are provided to one (front) side of the cassette, to assist in effective gripping of the cassette as it is presented to and removed from the machine.

Ideally, the outlet from the second chamber and the inlet to the first chamber are in close proximity, and when flexible connecting tubes are secured to an adaptor that can engage with the cartridge, and connect the first and second passageways to the connecting tubes.

The components of the means of the invention preferably are provided in a housing, having on one (front) panel a recess to which the cartridge can be applied, the rear wall of the recess having a through passage for the piston within the housing. Preferably co-operating locating means are provided on the cartridge and on the housing to hold the cartridge securely in the recess. The rear wall to the recess may have a connection to a source of low or negative pressure such as, for example a vacuum pump, and the cartridge may have an opening into the first chamber to which the connection is attached as the cartridge is inserted into the recess in the front panel of the housing. In the base of the recess, a bleed hole may be provided to provide a passageway for fluid externally of the machine, such that in the unlikely event of the cartridge leaking, or the fluid chamber being ruptured, fluid does not reach the inside of the machine.

The locating means to hold the cartridge in the recess in the housing may be provided by retractable tabs, that when withdrawn lie within the housing, and with the cartridge fitted into the recess in the housing, are moved through slots in the walls of the recess and into engagement with co-operating slots in the side walls of the cartridge. Each tab may have an associated solenoid activated by a switch on the rear wall of the recess on pressing the cartridge into place, and deactivated when power to the oral hygiene means is switched off at the end of an oral hygiene operation. Preferably, seals are provided through which the switch and the tabs respectively pass, to assist in the prevention of any leaked fluid reaching the inside of the machine. Still further preferable is the provision of a sensing means on the machine to sense the presence of a cartridge positioned on the machine and operate switch means to connect the machine to a source of electrical power.

The drive means for the piston may be a motor screw drive, or can be a stepping motor, and sealing rings may be provided to provide a seal between the piston and the passageway.

Thus, at the commencement of operations, power to the oral hygiene means is switched on, and a new cartridge applied to the recess on the casing. Its presence is sensed and power applied, first to activate the locking tabs. The vacuum pump is then switched on as is the drive motor for the piston, and such that the piston is urged into contact with the flexible membrane to urge fluid out of it and to the brush where it emerges in the vicinity of the bristle head, whilst at the same time a negative pressure is created in the inner chamber of the cartridge to create a suction effect in the second passageway in the brush. As teeth cleaning progresses, fluid is delivered to the mouth and extracted from the mouth at essentially the same rate to avoid flooding of the patient's mouth, and spent fluid returned to the inner chamber in the cartridge.

At the end of operations power is switched off, the cartridge locking means released, and the cartridge removed for disposal. To ensure the avoidance of spillage of spent fluid, closable valve means may be provided to close the outlet from the inner chamber as the cartridge is removed.

The brush may be disconnected from the cartridge prior to its disposal but for hospital and other institutional use, it is preferred that the brush is disposed of with the cartridge.

To increase the suitability of the oral hygiene means of the invention to hospital or other institutional use, and to use by such as qualified home health visitors, microprocessor control means may be provided, with at least one associated bar code reader, and the control means may include an overriding control preventing the unauthorised or improper use of the means of the invention. Thus, for each patient, a bar code sheet may be provided on which a number of bar codes are present, with hospital staff members having their own individual bar code. Thus, a member of staff intending to use the means of the invention would first cause his/her own bar code to be read, and then a bar code identifying the controlling doctor/consultant. Following this a bar code would be read to identify the patient, together with the bar code of a cartridge the member of staff intended to fit to the means of the invention and use on that patient. As an alternative, a second bar code reader can be positioned on the machine to read the bar code of a cartridge as it is fitted to the machine. With all of that information safely stored in the memory of the microprocessor the overriding lock is removed allowing the machine to be switched on, the cartridge applied and locked in place, and teeth cleaning effected. The stored information can subsequently be transferred to a hospitals main records data base. Equally possible is the pre-programming of the microprocessor to ensure that a correct cartridge is fitted to the housing suited to the needs of a particular patient.

Preferably, the housing is provided with a locating bracket to hold the at least one scanner in the form of a pen when not in use.

Two aspects of the invention will now be described by way of example only in the accompanying drawings in which:—

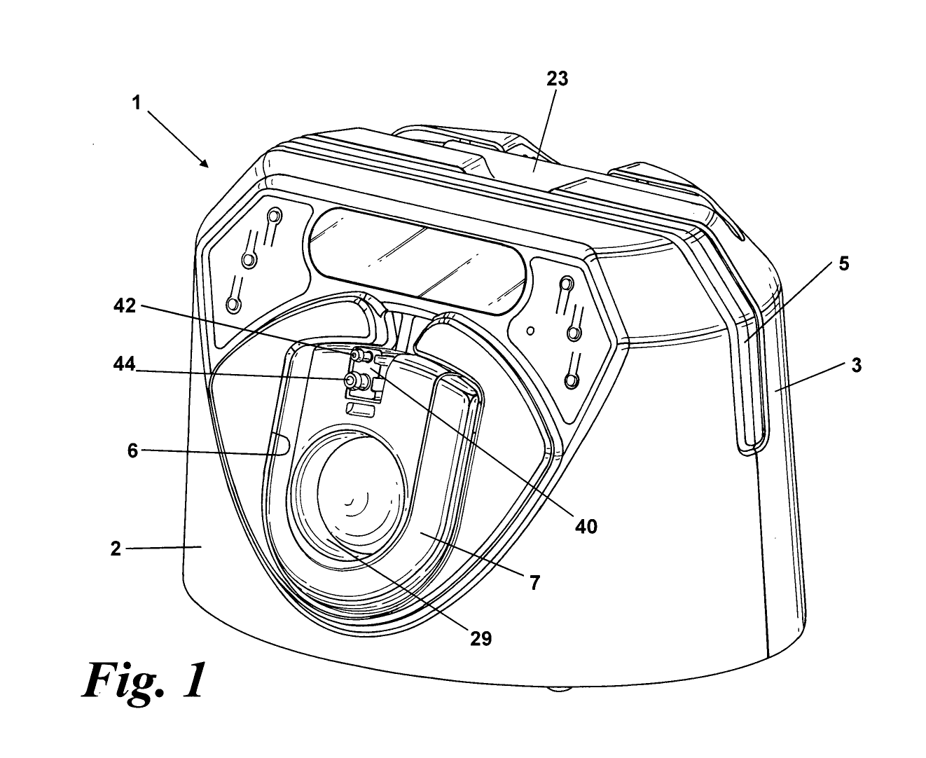

FIG. 1 is a front perspective view of oral hygiene means in accordance with the invention;

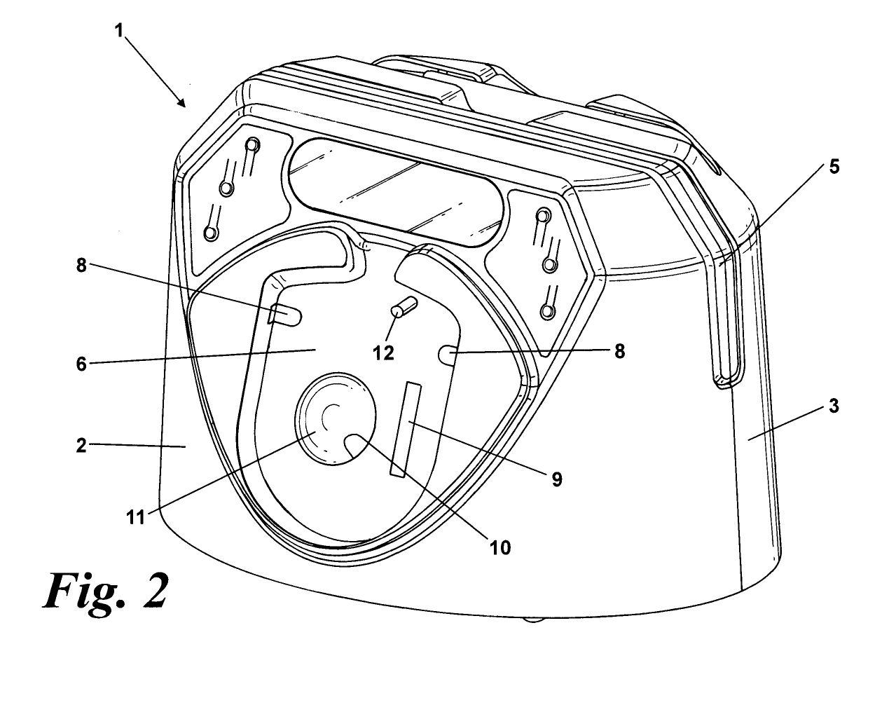

FIG. 2 corresponds to FIG. 1 but shows the cartridge removed;

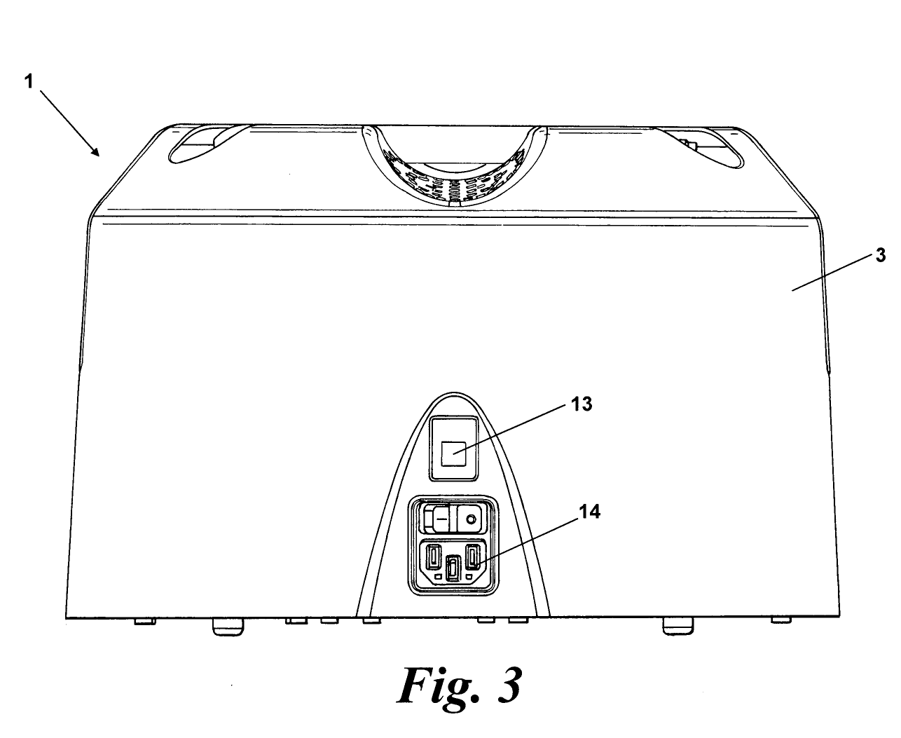

FIG. 3 is a rear elevation of FIG. 1;

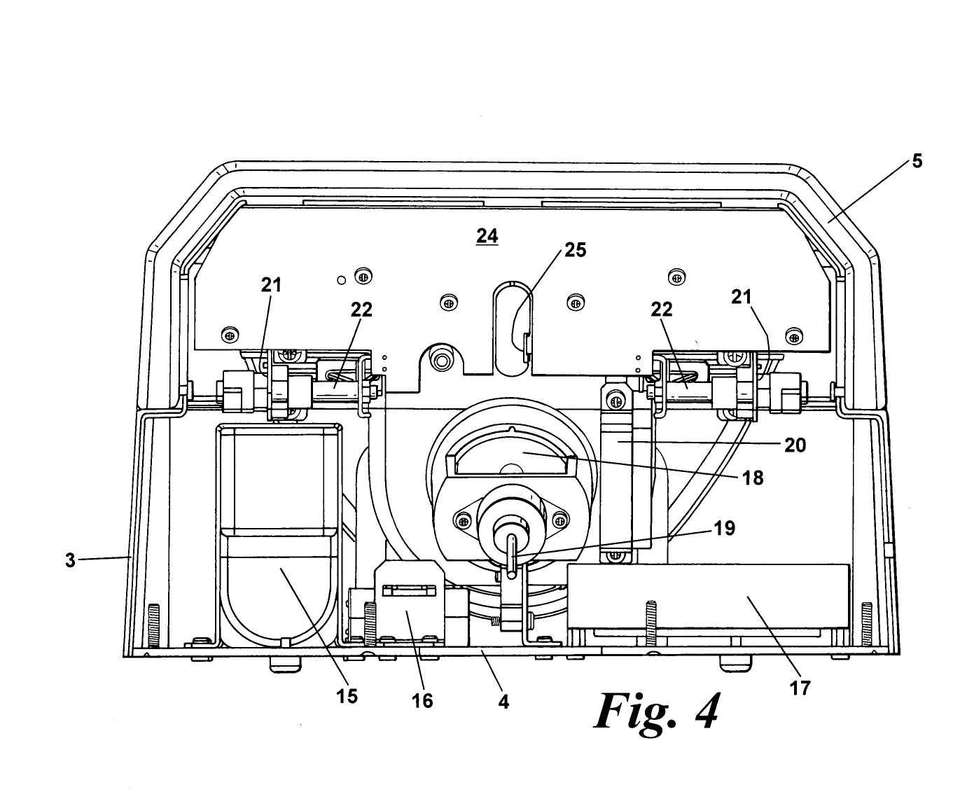

FIG. 4 is a front elevation of FIG. 1 with the front casing half removed;

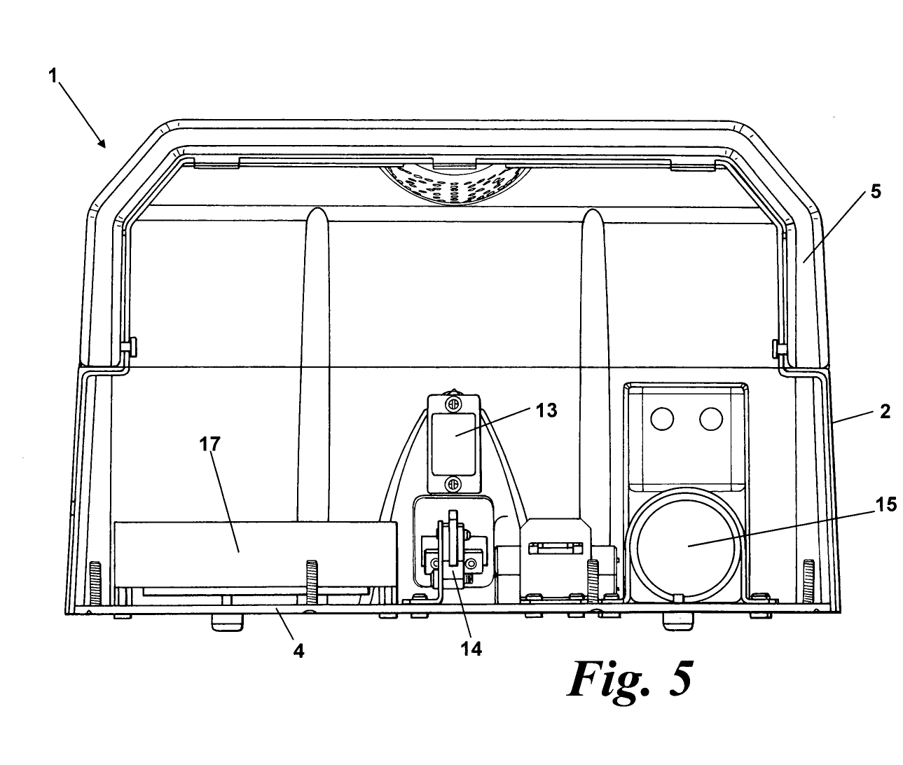

FIG. 5 is a rear elevation of FIG. 1 with the rear casing half removed;

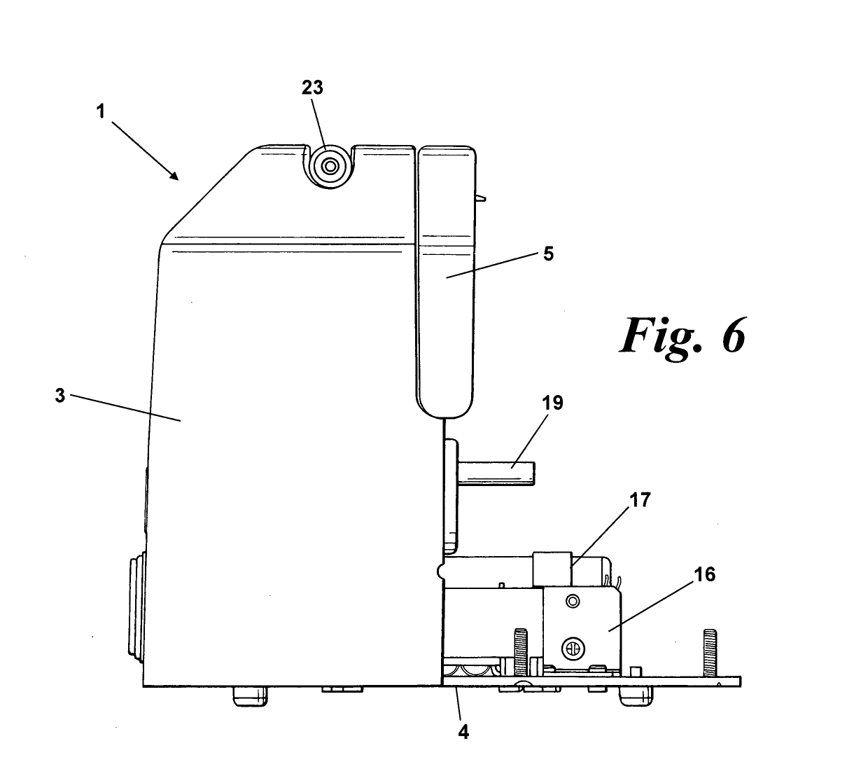

FIG. 6 is an elevation from one side of FIG. 1 with the front casing half removed;

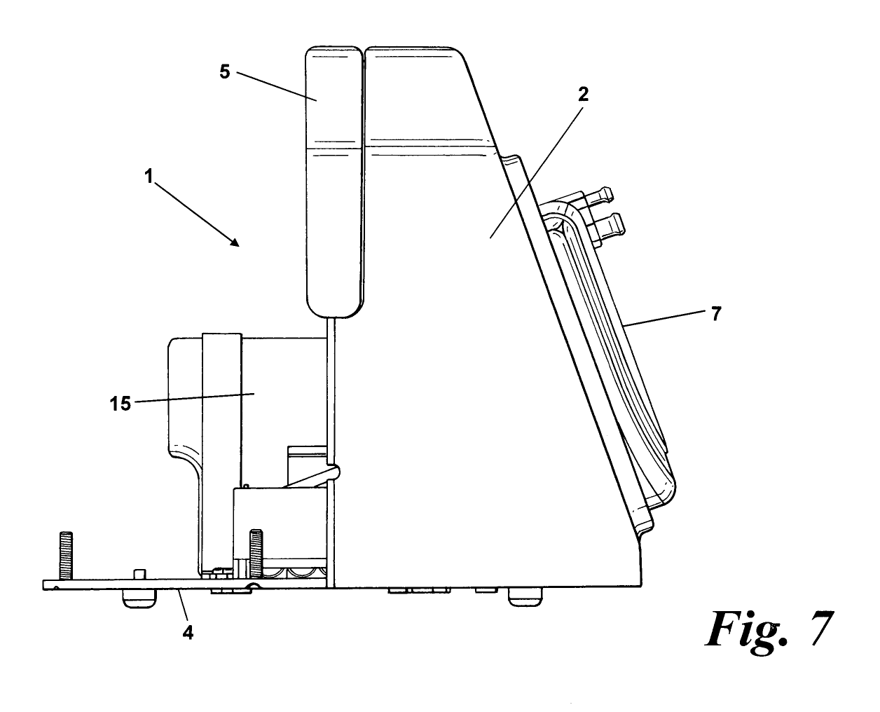

FIG. 7 corresponds to FIG. 6 but shows the rear casing half removed;

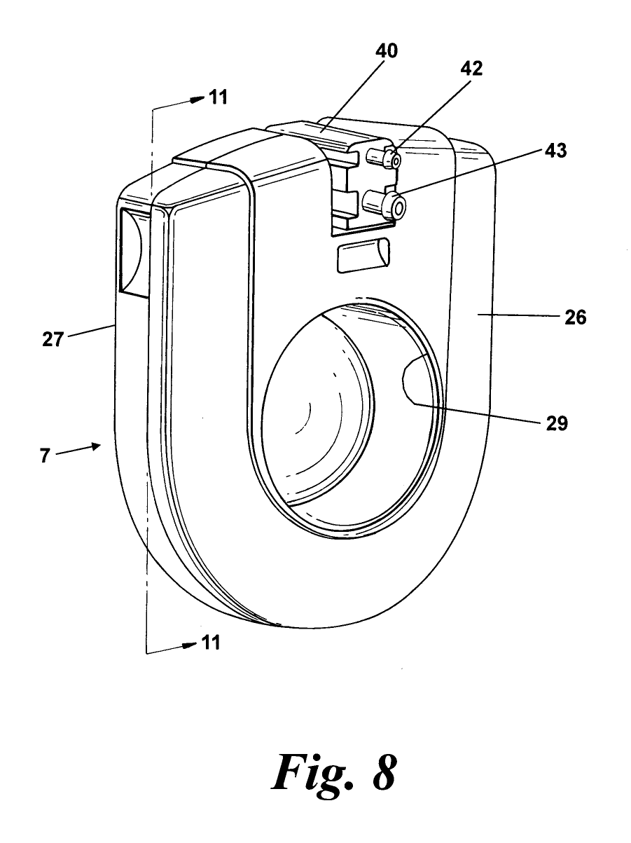

FIG. 8 is a perspective view of a second aspect of the invention, a cartridge for the machine of FIG. 1;

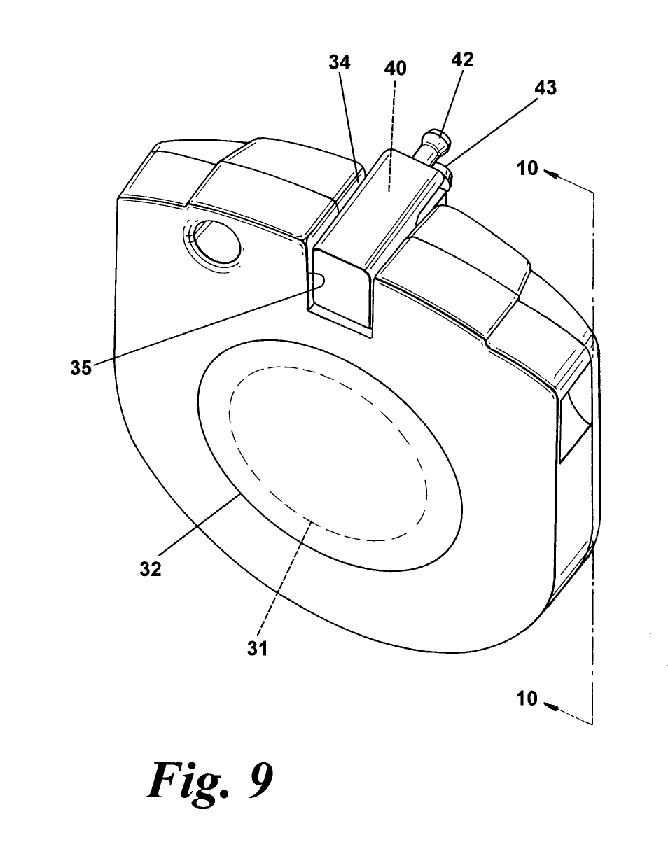

FIG. 9 is a rear perspective view of FIG. 8;

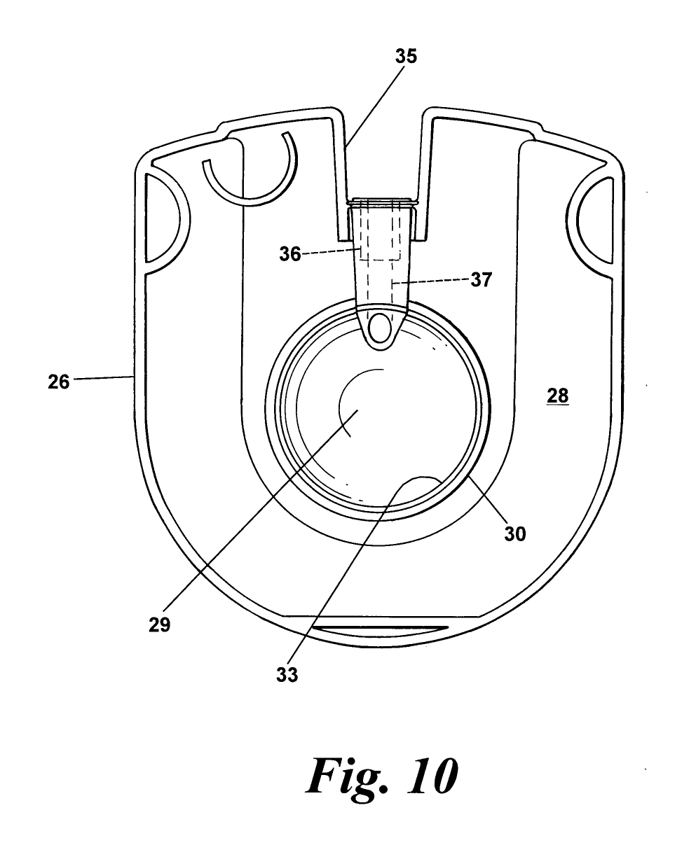

FIG. 10 is a section on the line 10-10 of FIG. 8;

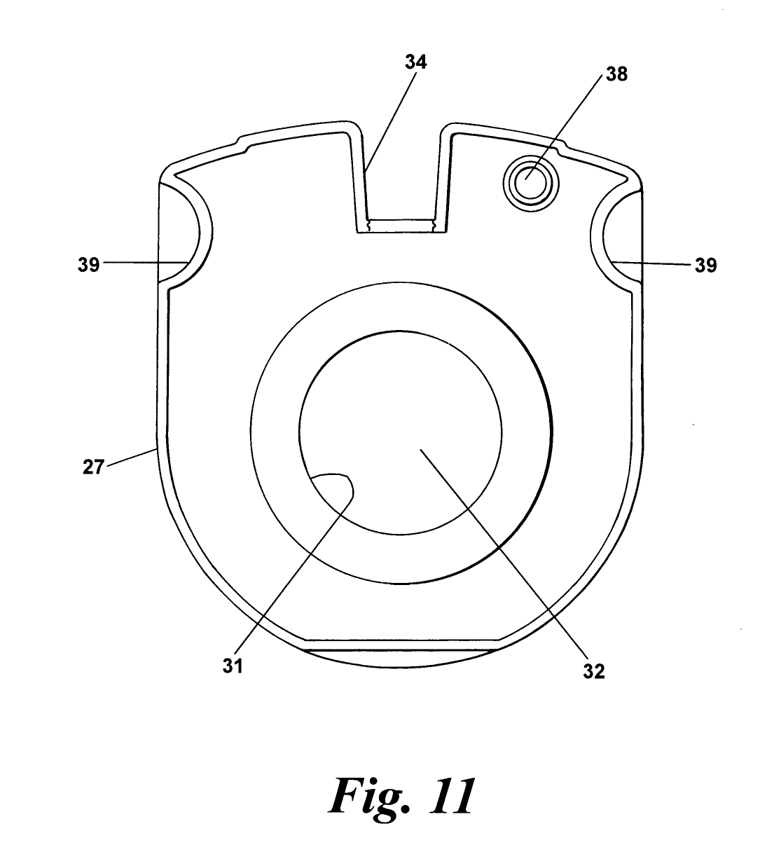

FIG. 11 is a section on the line 11-11 of FIG. 9; and

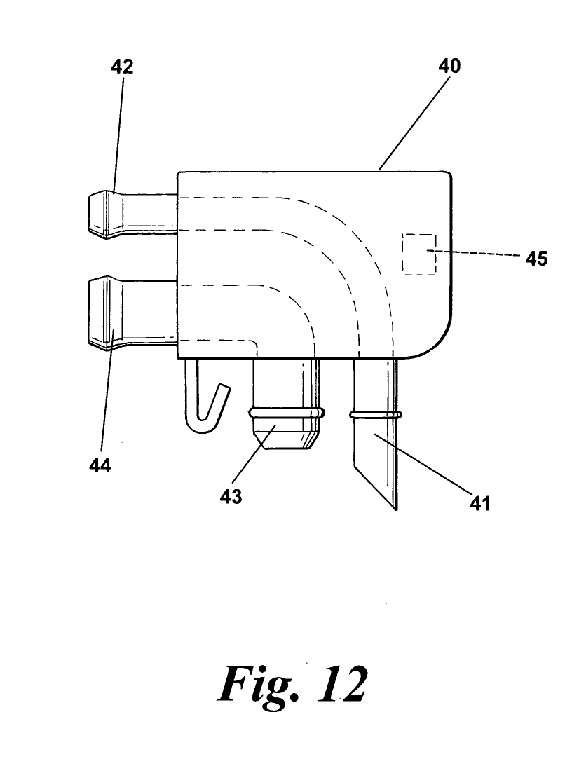

FIG. 12 is side elevation of the connector block of the cartridge.

In FIGS. 1 to 6, oral hygiene means comprises a machine 1 with front and rear casing halves 2, 3 mounted on a base 4, the machine having a retractable carrying handle 5.

To the front of the machine, the casing half 2 has a recess 6 to receive a cartridge 7, and as shown particularly in FIG. 2 there are retractable catches 8 to hold the cartridge in place extending through slots in the walls of the recess 6, recess 6 also having a window 9 of a bar code reader. Also on the front half 2 is a liquid crystal information display and signal LCD's to advise of the progress of the programme controlling the machine or to advise of a fault or malfunction. In the base of the recess 6 is a hole 10 through which projects a piston head 11, along with a connection 12 to a source of low pressure/vacuum.

As shown in FIG. 3, the rear casing half 2 has a USB connection 13 to connect the machine to an appropriate computer, and a mains electricity connecting socket 14.

As is shown by FIG. 4, where the front casing half is removed, within the casing is a vacuum pump 15 located on the base 4 connected to the connection 12. A battery pack 16 and a transformer 17 are also provided, both of which are connected to the socket 14, to allow re-chargeable batteries in the battery pack to be charged, and to provide low voltage power to operate the machine for the safety of the operative. Also mounted on the base is a piston actuator 18 such as for example a stepping motor, there being a piston drive shaft 19 to which the piston head 11 is secured. Adjacent the piston actuator is a bar code reader 20 associated with the window 9 (FIG. 2), and located on supports 21 fixed to the casing half 3 are actuators in the form of solenoids 22 on which the catches 8 are mounted. On the top face of the housing half 3 (FIG. 2) is a bar code reader in the form of a pen 23, and within the housing half 3 is a micro-processor printed circuit board 24.

Extending from the printed circuit board towards the front casing half 2 behind the recess 6 is a proximity sensor 25 to sense the presence of cartridge 7 positioned in the recess.

Illustrated in FIGS. 8 to 11 is the second aspect of the invention, the cartridge 7. The cartridge is formed as front and rear parts 26, 27 suitably bonded together, to form a cavity serving as the first chamber 28. The wall of the front part 26 is moulded with a recess 29 having a bulbous base, the recess 29 creating an inner cylindrical member 30 extending inwardly of the cartridge and of a length such that it is in contact with and bonded to the wall of the rear part 27. In the wall of the rear part is a circular opening 31 concentric with the cylindrical member 30 the opening being overlaid and closed by an impervious flexible membrane 32, also bonded to the rear part 27 whereby to create the second chamber 33 within the cartridge. The front and rear parts are formed with co=operating recesses 34, 35 in the bases of which are access holes 36, 37 leading, respectively to the first and second chambers. Also in the rear part 27 is an opening 38 to connect the first chamber 28 to a source of low pressure or vacuum.

To each side of the cartridge, recesses 39 are provided.

Fitted in the recesses 35, 36 is a connector block 40 having a connector 41 to engage the hole 37 with a passageway leading to an outlet 42 and a connector 43 to engage with hole 36 with a passageway leading to an inlet 44. In the connector block is an embedded magnet 45.

At its lower end, the cartridge is lipped to allow engagement by the fingers, to facilitate placement and removal of the cartridge.

A toothbrush of the type disclosed in U.S. Pat. No. 6,315,556, may be provided, with its fluid pipe attached to the outlet and its extraction pipe attached to the inlet.

Thus, and at the onset of the use of the machine, it is connected to mains via the socket 13 or is left to be operated by the battery pack 16. On the presentation of the cartridge 7 to the recess 6, the sensor 25 senses the presence of the magnet on the cartridge, and by being suitably connected to an appropriate switching means, power is provided to actuate the solenoids 22 to cause the latches 8 to engage the co-operating recesses 38 in the side walls of the cartridge. Simultaneously, the connection 12 engages the cartridge.

The bar code reader 19 via the window 9 reads a bar code on the cassette and provides that information to the micro-processor printed circuit board 24. At the same time, the bar code pen 23 is used to read a bar code identifying a patient, a nurse or other operative, and a doctor/consultant primarily responsible for that patients care. This information is provided to the micro-processor to be compared with pre-loaded information, and only when the micro-processor senses that the cartridge and its contents have been prescribed for that patient, can a signal be sent to the piston actuator 18 and the vacuum pump 15. Information regarding the nurse/operative and doctor/consultant is stored by records purposes.

Once the vacuum pump 15 and piston actuator 18 are activated, low pressure or vacuum is applied to the first chamber 28 of the cartridge, and the piston head is driven against and depresses the flexible membrane 32 of the cartridge. With the second chamber 33 of the cartridge pre-filled with an appropriate fluid, fluid is driven out of the second chamber and through the outlet 42 and then to the bristles of a toothbrush after the manner disclosed in U.S. Pat. No. 6,315,556, and simultaneously the low pressure or vacuum existing in the first chamber 28 causes fluid to be withdrawn from the mouth of the user to the inlet 44, from where it is deposited in the first chamber 28 for storage and subsequent disposal.

At the end of a tooth cleaning operation, power is removed from the micro-processor printed circuit board, such as by way of an appropriate main switch, to deactivate the solenoids 22 and allow the removal of the cartridge from the machine.

The micro-processor of itself has a memory in which can be stored the information regarding the cleaning of the teeth of a particular patient, but for longer term storage, the micro-processor can be connected to such as a main frame computer, into which all information from the memory of the micro-processor can be downloaded.

The first aspect of the invention provides a substantial guarantee that a correct and prescribed cartridge and its particular fluid filling is used on the correct patient, as well as creating a record of the nurse/operative who cleaned the patients teeth and the controlling physician.

The second aspect of the invention provides an ideal means of ensuring that a correct amount of a prescribed fluid is used, capable of easy and prolonged storage, and equally easy transport and disposal.

1. Oral hygiene means characterised by a chamber for active fluid to which a first passageway in a toothbrush is connectable, a flexible panel on the chamber, a piston to cooperate with the flexible panel, a drive means for the piston, a spent fluid chamber to which a second passageway in a toothbrush is connectable, and a means of creating a low or negative pressure connected to the spent fluid chamber, at least the chamber for fluid being disposable and replaceable for each oral hygiene operation.

2. Oral hygiene means as in claim 1, characterised in that the spent fluid chamber is also disposable and replaceable for each oral hygiene operation.

3. Oral hygiene means as in claim 1, characterised in that the chamber for fluid and the spent fluid chamber are a combined unit.

4. Oral hygiene means as in claim 1, characterised in that the said chambers are provided in a cartridge.

5. Oral hygiene means as in any of claim 1, characterised in that a housing is provided in which are located the components of the oral hygiene means.

6. Oral hygiene means as in claim 5, wherein the housing has a recess in which the cartridge is located.

7. Oral hygiene means as in claim 6, wherein the means to provide low or negative pressure is a vacuum pump located in the housing with an associated inlet in the recess for the cartridge.

8. Oral hygiene means as in claim 7, wherein the piston is within the housing, having a piston actuator with a piston head aligned with an opening in the base of the recess in the housing, to allow the piston to bear against the cartridge.

9. Oral hygiene means as in claim 8, wherein actuators are provided in the housing to move retractable tabs to lock and unlock the cartridge in the recess on the housing.

10. Oral hygiene means as in any claim 9, characterised in that sensor means are provided to sense the presence of a cartridge in the recess.

11. Oral hygiene means as in claim 10, wherein at least one bar code reader is provided.

12. Oral hygiene means as in claim 11, wherein two bar code readers are provided, one to read automatically a bar code on the cartridge as it is positioned in the recess on the housing and the other to read bar codes specific to a patient, an operative/nurse and an attending physician.

13. Oral hygiene means as in claim 12, wherein micro-processor means are provided to store relevant information and control the sequence of operation of the oral hygiene means.

14. A cartridge for use in oral hygiene means, characterised by a first chamber to serve as a spent fluid chamber, an outlet from the first chamber for connection to a source of low or negative pressure, an inlet to the first chamber for connection to a brush, there being a second chamber within the first chamber to contain active fluid, the second chamber extending from a co-operating hole in a wall of the cartridge, with a flexible membrane overlying the hole and being in sealing engagement with the wall of the cartridge around the hole, and an outlet connection from the second chamber for connection to a brush.

15. A cartridge as in claim 14, characterised in that the second chamber is a recess on the opposite wall of the cartridge to the wall with the hole, the wall of the recess extending across the cartridge and into sealing engagement with the wall around the hole.

16. A cartridge as in claim 15, characterised in that gripping means are provided to one (front) side of the cassette, to assist in effective gripping of the cassette as it is presented to and removed from the machine.

17. A cartridge as in claim 16, characterised in that the outlet from the second chamber and the inlet to the first chamber are in close proximity, and when flexible connecting tubes are secured to an adaptor that can engage with the cartridge, and connect the first and second passageways to the connecting tubes.

18. A cartridge for use in oral hygiene means characterised by front and rear parts suitably bonded together to form a cavity serving as a first chamber, the wall of the front part being moulded with a recess having a bulbous base, which recess creates an inner cylindrical member extending inwardly of the cartridge and being of a length such that it is in contact with and is bonded to the wall of the rear part, the wall of the rear part having a circular opening concentric with the cylindrical member with an impervious flexible membrane overlying and closing the circular opening to create a second chamber, there being an inlet opening to the first chamber and an outlet opening from the second chamber, connected to a connector block attached to the cartridge, the wall of the rear part having a means for connection to a source of low or negative pressure.

19. A cartridge as in claim 18, characterised in that a gripping means is provided to allow for easy placement and removal of a cartridge.
